(19) United States
(12) Patent Application Publication
(10) Pub. No.: US 2005/0023800 A1
(43) Pub. Date: Feb. 3, 2005

(54) Foldable golf cart

(76) Inventors: Pao-Hsien Cheng, Tainan Hsien (TW); Ying-Hsiung Cheng, Tainan Hsien (TW); Michel Don Wade, San Diego, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/631,817

(22) Filed: Aug. 1, 2003

(51) Int. Cl. B62B 1/00

(52) U.S. Cl. 280/652

(57) ABSTRACT

A foldable golf cart includes a main support member, and a handle rod pivoted to an upper end of the main support member; the handle rod has a fixing hook pivoted thereto by means of a pivotal element; the main support member has an engaging protrusion; the fixing hook is engaged with the engaging protrusion to secure the handle rod to the main support member after the golf cart is stretched; the fixing hook is disengaged from the engaging protrusion for allowing a user to pivot the handle rod on the main support member to fold the golf cart.

### BACKGROUND OF THE INVENTION

1. Field of the Invention

The present invention relates to a foldable golf cart, more particularly one, which is uncomplicated in structure, and easy to use.

2. Brief Description of the Prior Art

Golf carts are usually made to be foldable so that the size thereof can be reduced for easier storage and transportations. Referring to FIGS. 9 to 11, a conventional foldable golf cart includes a main supporting member 10, two wheel supports 11 pivoted to the main supporting member 10, a handle rod 13 pivoted to the main supporting member 10 at a lower end, a connecting element 15, wheels (not shown) connected to lower ends of the wheel supports 11, and co-moving rods 14; the connecting element 15 is pivoted to a lower portion of the handle rod 13, and is biased towards an engaging position by means of a spring 16, which is connected to both the element 15 and the rod 13 at two ends; the co-moving rods 14 are pivoted to the handle rod 13 at first ends, and pivoted to respective wheel supports 11 at the other ends.

The connecting element 15 is engaged with the top of the main supporting member 10 to fix the handle rod 13 to the supporting member 10 when the golf cart is in a stretched position. To fold the golf cart, the connecting element 15 is first pivoted upwards so as to disengage the top of the main supporting member 10, and the handle rod 13 is pivoted down. Thus, the handle rod 13 and the wheel supports 1 are close to the main supporting member 10.

The golf cart is found to have disadvantages as followings:

1. There will be small space between the connecting element 15 and the top of the supporting member 10 after the element 15 is engaged with the top of the member 10 under the stretched position of the golf cart. Consequently, the golf cart is prone to become shaky through use for certain period of time, and will cause noise due to friction between the parts.

2. When the connecting element 15 is being disengaged from the supporting member 10, the spring 16 will be made to stretch by a force that is not along it. Consequently, the spring 16 is prone to change shape, and lose elasticity after long period of use.

3. The user has to use two hands to fold the golf cart, pulling up the connecting element 15 with one hand, and moving the handle rod 13 with the other, therefore the golf cart is not ideal in terms of easiness in operation.

4. There are relatively many parts associated with the folding mechanism of the golf cart. Consequently, the appearance of the cart is spoiled, and the cart takes more labor and time to assemble.

### SUMMARY OF THE INVENTION

It is a main object of the present invention to provide a golf cart to overcome the above disadvantages.

The foldable golf cart includes a main support member having two wheeled supports pivoted thereto, a handle rod pivoted to the main support member, and two co-moving rods pivoted to the handle rod at upper ends, and pivoted to respective ones of the wheeled supports at lower ends; the handle rod has a fixing hook pivoted thereto by means of a pivotal element; the main support member has an engaging protrusion; the fixing hook is engaged with the engaging protrusion to secure the handle rod to the main support member after the golf cart is stretched; a cover is fitted to the fixing hook.

### BRIEF DESCRIPTION OF THE DRAWINGS

The present invention will be better understood by referring to the accompanying drawings, wherein:

FIG. 1 is a side view of the golf cart of the present invention, in the stretched position,

FIG. 2 is a partial exploded perspective view of the golf cart according to the present invention,

FIG. 3 is a partial front view of the golf cart of the present invention, in the stretched position,

FIG. 4 is a partial side view of the golf cart of the present invention, in the stretched position,

FIG. 5 is a partial front view of the golf cart of the present invention with the engaging hook being in the disengaged position,

FIG. 6 is a partial front view of the golf cart of the present invention, in the folded position,

FIG. 7 is a side view of the golf cart of the present invention, in the folded position,

FIG. 8 is a front view of the engaging hook of the golf cart of the present invention, in the laid down position for packaging of the cart,

FIG. 9 is a perspective view of the conventional golf cart as described in the Background,

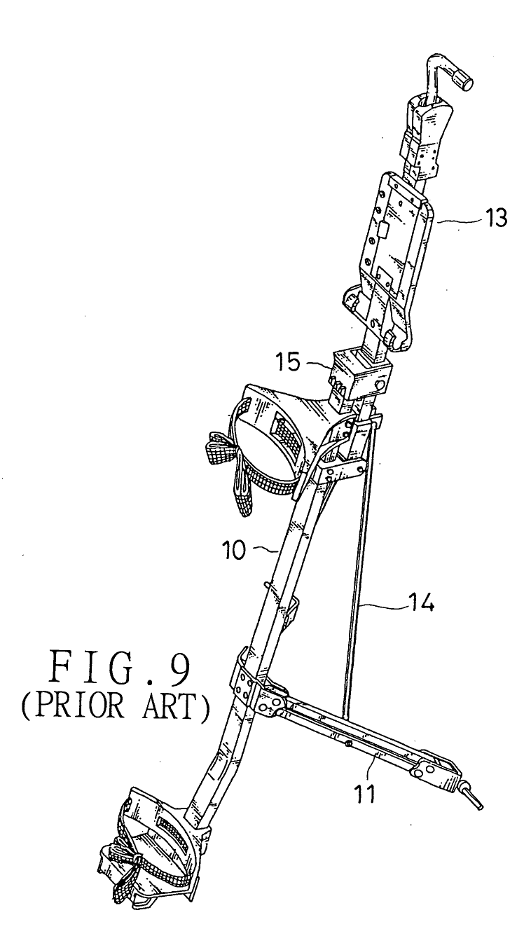

FIG. 10 is a partial side view of the conventional golf cart, and

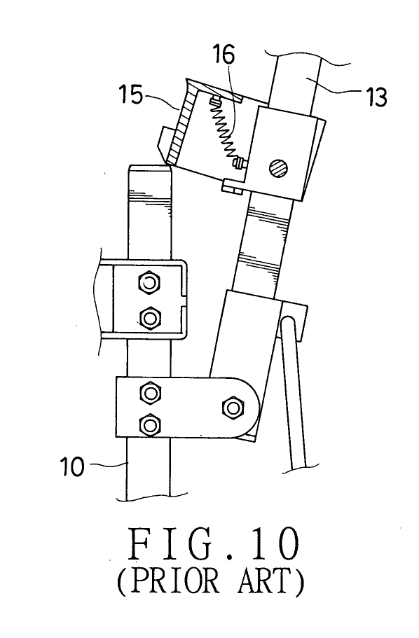

FIG. 11 is another partial side view of the conventional golf cart.

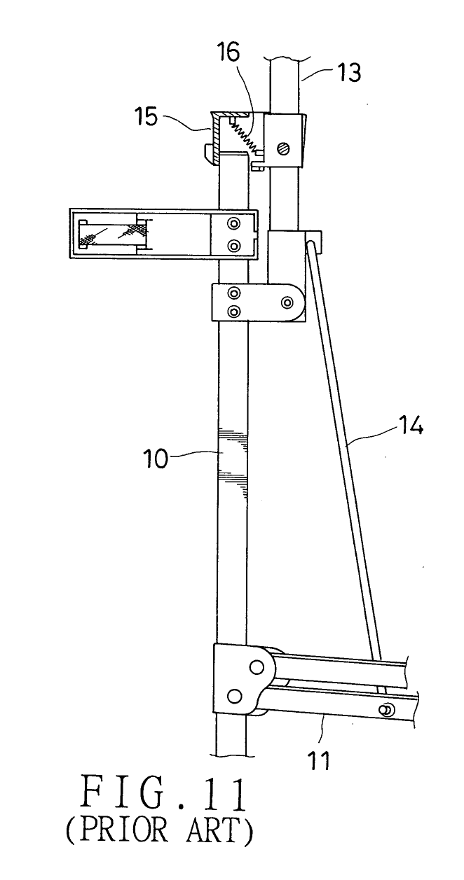

### DETAILED DESCRIPTION OF THE PREFERRED EMBODIMENTS

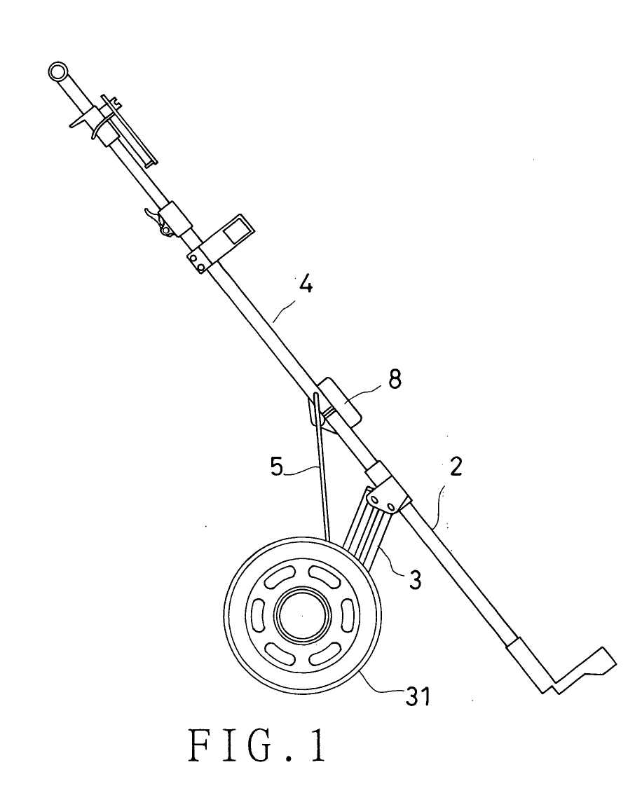

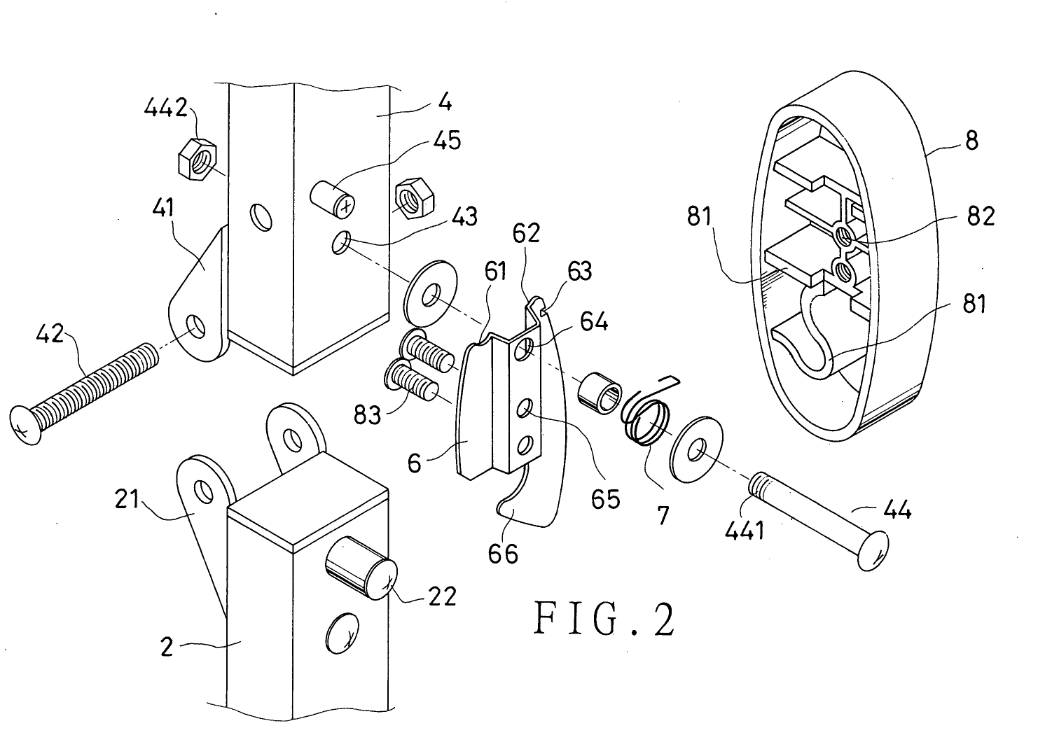

Referring to FIGS. 1, and 2, a preferred embodiment of a foldable golf cart in the present invention includes a main support member 2, two wheel supports 3 pivoted to the main support member 2 at upper ends, wheels 31 connected to lower ends of the wheel supports 3, a handle rod 4, two co-moving rods 5, and a fixing hook 6.

The main support member 2 has two opposing connecting ears 21 projecting from a rear side of an upper end, and an engaging protrusion 22 on a front side of the upper end. The connecting ears 21 have pivotal holes (not numbered) opposing each other.

The handle rod 4 has two opposing connecting ears 41 projecting from a rear side of a lower end, a through hole 43 extending from a front side to a rear side, and a locating protrusion 45 on the front side. The connecting ears 41 have pivotal holes (not numbered) opposing each other. The handle rod 4 is pivoted to the main support member 2 by means of a pivotal rod 42, which is passed through the pivotal holes of the connecting ears 21 and 41, and screwed into a nut (not numbered); thus, the golf cart can be folded by means of pivoting the handle rod 4 close to the rear side of the main support member 2.

The co-moving rods 5 are pivoted to the handle rod 4 at upper ends, and pivoted to respective ones of the wheel supports 5 at lower ends.

Referring to FIGS. 2 to 4, the fixing hook 6 has two separate concavely curved locating gaps 61, 62 on a top thereof, an engaging gap 63 on an upper end of a first lateral edge, a through hole 64 neat to the top, connecting holes 65, and a hook portion 66 projecting from the lower end and in the same direction as the other lateral edge. The fixing hook 6 is pivoted to the front side of the handle rod 4 by means of a pivotal element 44, which is passed through the through holes 64 and 43, and screwed into a nut 442 at a threaded tail end 441 thereof; a torsion spring 7 is passed around the pivotal element 44, and connected to the engaging gap 63 of the fixing hook 6, and the locating protrusion 45 of the handle rod 4 at two ends thereof.

A cover 8 is provided for the fixing hook 6, which has screw holes 82, and a stopping portion 81 therein. The cover 8 is fitted to an outward side of the fixing hook 6 with the screw holes 82 being aligned with respective ones of the connecting holes 65, and with the stopping portion 81 stopping the lower portion of the fixing hook 6 from moving inwardly of the cover 8; threaded fixing elements 83 are passed through the connecting holes 65, and screwed into the screw holes 82 to secure the cover 8 to the fixing hook 6.

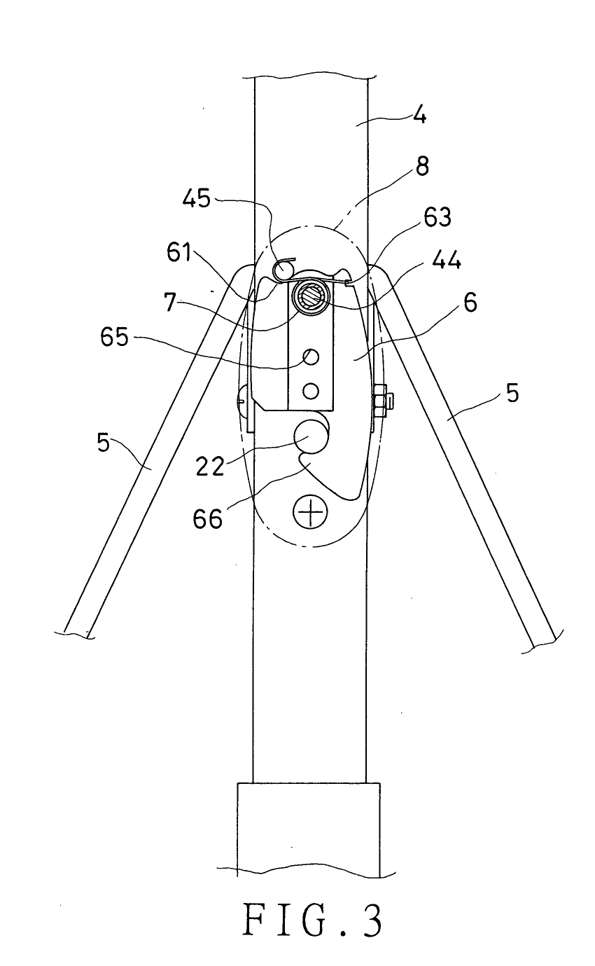

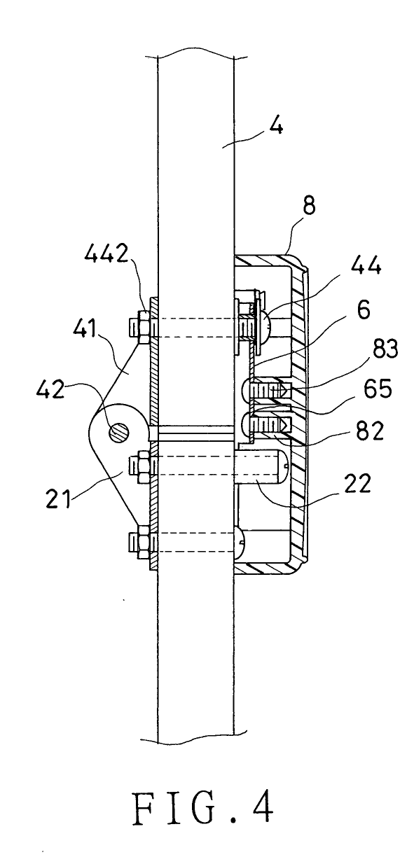

Referring to FIGS. 3, and 4, the fixing hook 6 is engaged with the engaging protrusion 22 of the main support member 2 at the lower hook portion 66 thereof while the concavely curved locating gap 61 is engaged with the locating protrusion 45 after the golf cart is stretched; thus, the handle rod 4 can't move relative to the main support member 2.

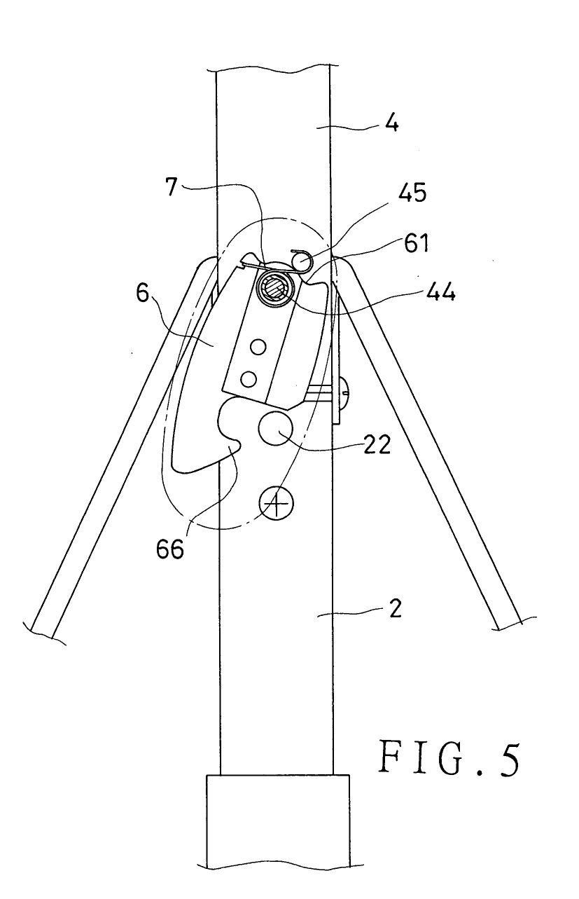

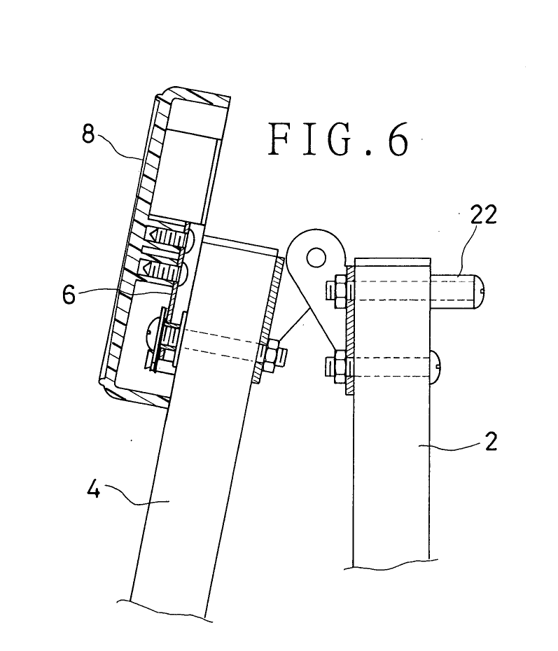

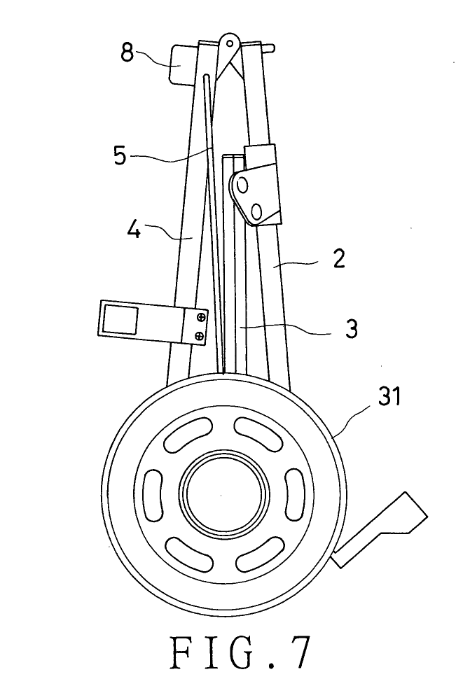

Referring to FIG. 5, to fold the golf cart, the fixing hook 6 with the cover 8 is first pivoted away from the engaging protrusion 22, and the handle rod 4 is pivoted down and close to the rear side of the main support member 2. Thus, the wheel supports 3 are made to move together with the handle rod 4 to become close to the main support member 2 by means of the co-moving rods 5, and the golf cart is folded, as shown in FIGS. 6, and 7.

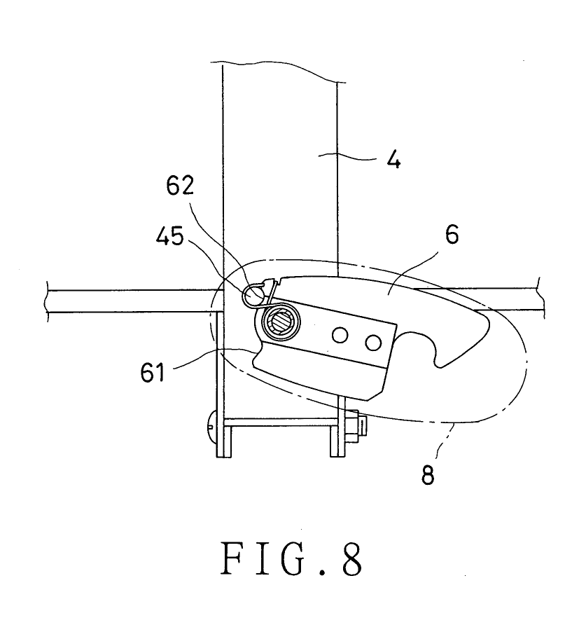

Referring to FIG. 8, the fixing hook 6 with the cover 8 is laid substantially horizontal, and fixed in position with the concavely curved locating gap 62 engaging the locating protrusion 45 after the golf cart is folded; thus, the folded golf cart occupies less space, and can be held in a smaller case.

From the above description, it can be easily understood that the foldable golf cart of the present invention has advantages as followings:

1. Because the lower end of the handle rod 4 contacts the top of the main support member 2 closely without any space in between when the golf cart is in the stretched position, the golf cart won't be shaky or cause noise when it is used.

2. When the fixing hook 6 is pivoted on the pivotal element 44, force exerted on the torsion spring 7 is along the direction in which the spring 7 is wound. Therefore, the torsion spring 7 won't change shape even after long time of use.

3. The user only has to use one hand to fold the golf cart therefore the cart is ideal in terms of easiness in operation.

4. The folding mechanism of the present cart consists of fewer parts than that of the conventional one therefore the present cart takes less labor and time to assemble. And, the fixing hook 6, the engaging protrusion 22, the spring 7, the locating protrusion 45, and the pivotal element 44 won't show to spoil the appearance of the golf cart due to the cover 8.

1. A foldable golf bag cart, comprising
a main support member having two wheeled supports pivotally coupled thereto;
a handle rod pivotally coupled to an upper end of the main support member at a lower end thereof; and
two co-moving rods pivotally coupled to the handle rod at upper ends of the two co-moving rods, and pivotally coupled to respective ones of the wheeled supports at lower ends of the two co-moving rods;
the handle rod having a fixing hook pivotally coupled thereto by means of a pivotal element; the main support member having an engaging protrusion thereon; the fixing hook being engagable with the engaging protrusion to prevent the handle rod from moving relative to the main support member when the golf bag cart is in a stretched position, the handle rod having a through hole, and the fixing hook having a through hole, the pivotal element being passed through the through holes of the handle rod and the fixing hook, the pivotal element being threaded into a nut at a threaded tail end thereof.

2. The foldable golf bag cart as claimed in claim 1, wherein the main support member has a plurality of connecting ears with opposing pivotal holes formed therein, and the handle rod has a plurality of connecting ears with opposing pivotal holes formed therein, and a pivotal rod is passed through the opposing pivotal holes of the connecting ears of the main support member and the opposing pivotal holes of the connecting ears of the handle rod.

3 (Canceled).

4. A foldable golf bag cart, comprising:
a main support member having two wheeled supports pivotally coupled thereto;
a handle rod pivotally coupled to an upper end of the main support member at a lower end thereof;
two co-moving rods pivotally coupled to the handle rod at upper ends of the two co-moving rods, and pivotally coupled to respective ones of the wheeled supports at lower ends of the two co-moving rods, the handle rod having a fixing hook pivotally coupled thereto by means of a pivotal element, the main support member having an engaging protrusion thereon, the fixing hook being engagable with the engaging protrusion to prevent the handle rod from moving relative to the main support member when the golf bag cart is in a stretched position; and,
a torsion spring passed around the pivotal element and respectively connected to both an engaging gap of the fixing hook and a locating protrusion of the handle rod at two ends thereof.

5. A foldable golf bag cart, comprising:
a main support member having two wheeled supports pivotally coupled thereto;
a handle rod pivotally coupled to an upper end of the main support member at a lower end thereof;
two co-moving rods pivotally coupled to the handle rod at upper ends of the two co-moving rods, and pivotally coupled to respective ones of the wheeled supports at lower ends of the two co-moving rods, the handle rod having a fixing hook pivotally coupled thereto by means of a pivotal element, the main support member having an engaging protrusion thereon, the fixing hook being engagable with the engaging protrusion to prevent the handle rod from moving relative to the main support member when the golf bag cart is in a stretched position; and,
a cover fitted over the fixing hook.

6. The foldable golf bag cart as claimed in claim 5, wherein the fixing hook has a plurality of connecting holes, and the cover has threaded holes aligned with respective ones of the connecting holes, and threaded fixing elements are passed through the connecting holes, and threaded into the threaded holes to secure the cover to the fixing hook.

7. The foldable golf bag cart as claimed in claim 5, wherein the cover has a stopping portion disposed adjacent the hook portion of the fixing hook.

8. The foldable golf bag cart as claimed in claim 1, wherein the handle rod has a locating protrusion, and the fixing hook has two concavely curved locating gaps on a top thereof for acting as stops with respect to the locating protrusion responsive to pivotal movement of the fixing hook on the pivotal element in either of the two opposing directions.
